(19) United States
(12) Patent Application Publication
(10) Pub. No.: US 2008/0075989 A1
(43) Pub. Date: Mar. 27, 2008

(54) Fuel cell, fuel cell stack, fuel cell apparatus and electronic instrument

(75) Inventors: Tadao Yamamoto, Tokyo (JP); Shinichi Miyamoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/903,676

(22) Filed: Sep. 24, 2007

(30) Foreign Application Priority Data
Sep. 26, 2006 (JP) 2006-261028

(51) Int. Cl. H01M 8/06; H01M 8/24

(52) U.S. Cl. 429/19; 429/34

(57) ABSTRACT

Disclosed is a fuel cell comprising an electric cell in which an anode is formed on one surface of an electrolyte and a cathode is formed on the other surface of the electrolyte; a fuel gas supply section which is disposed on a side of the anode and which is formed with a fuel gas supply flow passage through which fuel gas is supplied to the anode; and an oxidation gas supply section which is disposed on a side of the cathode and which is formed with an oxidation gas supply flow passage through which oxidation gas is supplied to the cathode, wherein at least one flow passage of the fuel gas supply flow passage and the oxidation gas supply flow passage is substantially rectangular in shape.

### BACKGROUND OF THE INVENTION

1. Field of the Invention

The present invention relates to a fuel cell, a fuel cell stack, a fuel cell apparatus and an electronic instrument for taking out electricity by an electrochemical reaction between fuel gas and oxidation gas.

2. Description of the Related Art

A fuel cell takes out electricity by an electrochemical reaction between hydrogen and oxygen. As one type of a fuel cell, a solid oxide fuel cell (hereinbelow referred to as SOFC) has excellent electricity generating efficiency because SOFC is operated at a high temperature. In the solid oxide fuel cell, an electricity generating cell in which a fuel electrode (anode) is formed on one surface of a solid electrolyte and an oxygen electrode (cathode) is formed on the other surface, is used.

For example, as described in Japanese Patent Application Laid-open Publication No. 2006-85982, oxygen supplied to the oxygen electrode becomes ions (O²⁻), the ions penetrate the solid oxide electrolyte and reach the fuel electrode. The ions (O²⁻) oxidize fuel gas supplied to the fuel electrode and discharge electrons. Here, the fuel gas is mainly hydrogen gas. For example, hydrogen gas which is obtained by reforming fuel including hydrogen atom in the composition thereof such as methanol, or carbon monoxide which is obtained as by-product is used as the fuel gas.

In an electricity generating system using a fuel cell, conventionally, a diaphragm is provided in a separator and a flow passage having a bellows shape is formed to enhance the reaction efficiency of fuel gas and oxygen in the air. Therefore, the width of the flow passage is relatively narrow and the entire length of the flow passage is relatively long. Generally, a pressure loss is increased as the flow passage becomes longer or narrower.

When the pressure loss is increased, a pressure generated by a pump which sends fuel gas and air to the electricity generating cell is increased. Therefore, the pump is increased in size and as a result, the fuel cell apparatus is increased in size.

### BRIEF SUMMARY OF THE INVENTION

The present invention has an advantage that the fuel cell apparatus can be reduced in size.

To obtain such an advantage, a fuel cell of the preferred embodiment of the present invention comprises:

an electric cell in which an anode is formed on one surface of an electrolyte and a cathode is formed on the other surface of the electrolyte;

a fuel gas supply section which is disposed on a side of the anode and which is formed with a fuel gas supply flow passage through which fuel gas is supplied to the anode; and

an oxidation gas supply section which is disposed on a side of the cathode and which is formed with an oxidation gas supply flow passage through which oxidation gas is supplied to the cathode, wherein

at least one flow passage of the fuel gas supply flow passage and the oxidation gas supply flow passage is substantially rectangular in shape.

To obtain such an advantage, a fuel cell stack of the preferred embodiment of the present invention comprises a plurality of fuel cells, wherein each of the fuel cells includes;

an electric cell in which an anode is formed on one surface of an electrolyte and a cathode is formed on the other surface of the electrolyte;

a fuel gas supply section which is disposed on a side of the anode and which is formed with a fuel gas supply flow passage through which fuel gas is supplied to the anode; and

an oxidation gas supply section which is disposed on a side of the cathode and which is formed with an oxidation gas supply flow passage through which oxidation gas is supplied to the cathode, wherein

the plurality of fuel cells are disposed such that anodes or cathodes of the electric cells of adjacent fuel cells are opposed to each other.

### BRIEF DESCRIPTION OF THE SEVERAL VIEWS OF THE DRAWINGS

The present invention will be understood more sufficiently by the following detailed description and accompanying drawings, but the description and the drawings are presented for purposes of illustration only and not of limitation: wherein,

FIG. 1 is a block diagram showing a portable electronic instrument provided with a fuel cell apparatus therein;

FIG. 2A is a schematic diagram of an electricity generating cell;

FIG. 2B is a schematic diagram of a cell stack in which a plurality of electricity generating cells are serially connected to one another;

FIG. 3 is a perspective view of a thermal insulation package;

FIG. 4 is a perspective view showing an internal structure of the thermal insulation package;

FIG. 5 is a perspective view of the internal structure of the thermal insulation package in FIG. 4 viewed from below;

FIG. 6 is a sectional view taken along the line VI-VI in FIG. 3;

FIG. 7 is a bottom view of a connecting portion, a reformer, a connecting portion and a fuel cell portion;

FIG. 8 is a sectional view taken along the line VIII-VIII in FIG. 7;

FIG. 9 is a sectional view taken along the line IX-IX in FIG. 7;

FIG. 10 is a sectional view taken along the line X-X in FIG. 9;

FIG. 11 is a schematic diagram showing a temperature distribution in a thermal insulation package at the time of steady operation;

FIG. 12 is a perspective view showing a structure of a flow passage in the thermal insulation package;

FIG. 13 is a perspective view showing a flow passage on the side of an anode;

FIG. 14 is a perspective view showing a flow passage on the side of a cathode;

FIG. 15 is a perspective view showing a structure of a flow passage in a fuel cell portion;

FIG. 16A is a schematic diagram showing a flow of reformed gas in a fuel supply flow passage;

FIG. 16B is a schematic diagram showing a flow of air in an oxygen supply flow passage;

FIG. 17A is a schematic diagram showing the flow of the reformed gas in the fuel supply flow passage when a height of the flow passage is higher than 500 μm;

FIG. 17B is a schematic diagram showing the flow of the air in the oxygen supply flow passage when the height of the flow passage is higher than 500 μm;

FIG. 18A shows a result of a simulation of flows of the reformed gas and the air in the fuel supply flow passage;

FIG. 18B shows a result of a simulation of flows of the reformed gas and the air in the oxygen supply flow passage;

FIG. 19A is a schematic diagram showing another embodiment of each flow passage;

FIG. 19B is a schematic diagram showing another embodiment of each flow passage;

FIG. 19C is a schematic diagram showing another embodiment of each flow passage;

FIG. 19D is a schematic diagram showing another embodiment of each flow passage;

FIG. 19E is a schematic diagram showing another embodiment of each flow passage;

FIG. 20A is a schematic diagram showing a modified example of a stack structure of the electricity generating cell;

FIG. 20B is a circuit diagram of FIG. 20A;

FIG. 21A is a plan view showing a diaphragm material superposed on a fuel electrode;

FIG. 21B is a front view of FIG. 21A;

FIG. 22A is a plan view showing a diaphragm material superposed on an oxygen electrode; and

FIG. 22B is a front view of FIG. 22A.

### DETAILED DESCRIPTION OF THE PREFERRED EMBODIMENT

The preferred embodiment for carrying out the present invention will be explained using the drawings. In the following embodiment, technically preferable various definitions are added for carrying out the invention, but scopes of the invention are not limited to the embodiment and illustrated examples.

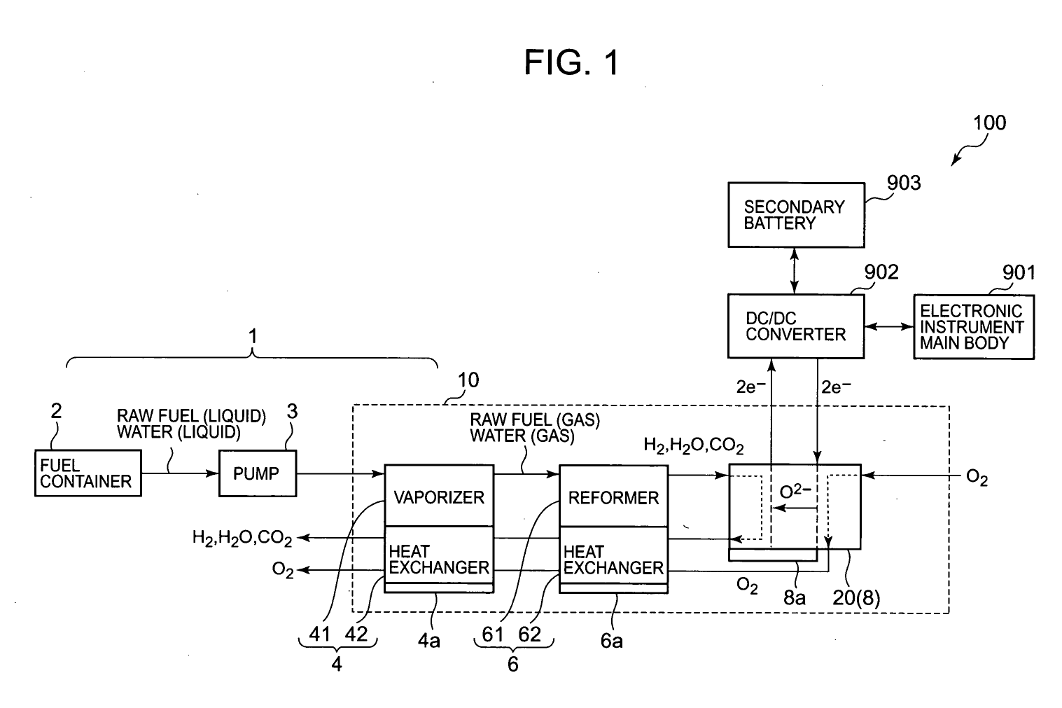

FIG. 1 is a block diagram showing a portable electronic instrument 100 provided with a fuel cell apparatus 1 therein. The electronic instrument 100 is a portable electronic instrument such as a notebook personal computer, a PDA, an electron notepad, a digital camera, a cellular phone, a watch, a register and a projector.

The electronic instrument 100 comprises a fuel cell apparatus 1, a DC/DC converter 902 which converts electric energy produced by the fuel cell apparatus 1 into appropriate voltage, a secondary battery 903 connected to the DC/DC converter 902, and an electronic instrument main body 901 to which electric energy is supplied by the DC/DC converter 902.

As described later, the fuel cell apparatus 1 produces electric energy and outputs the produced electric energy to the DC/DC converter 902. The DC/DC converter 902 converts electric energy produced by the fuel cell apparatus 1 into appropriate voltage and then supplies the electric energy to the electronic instrument main body 901. In addition, the DC/DC converter 902 also puts a secondary battery 903 on charge using electric energy produced by the fuel cell apparatus 1, and when the fuel cell apparatus 1 is not operated, the DC/DC converter 902 supplies the electric energy stored in the secondary battery 903 to the electronic instrument main body 901.

Next, the fuel cell apparatus 1 will be explained in detail. The fuel cell apparatus 1 comprises a fuel container 2, a pump 3, a thermal insulation package 10, etc. The fuel container 2 of the fuel cell apparatus 1 is detachably attached to the electronic instrument 100. The pump 3 and the thermal insulation package 10 are incorporated in the main body.

A liquid mixture of water and liquid raw fuel (e.g., methanol, ethanol, dimethyl ether) is stored in the fuel container 2. Liquid raw fuel and water may be stored in separate containers.

The pump 3 sucks liquid mixture in the fuel container 2 and sends the liquid mixture to a vaporizing section 4 in the thermal insulation package 10.

A pressure in the box-like thermal insulation package 10 is maintained at a vacuum pressure (e.g., 10 Pa or lower), and the vaporizing section 4, a reforming section 6 and a fuel cell portion 20 are accommodated in the thermal insulation package 10. The vaporizing section 4 comprises a vaporizer 41 and a heat exchanger 42 which are integrally formed together. The reforming section 6 comprises a reformer 61 and a heat exchanger 62 which are integrally formed together. An electricity generating cell 8 is accommodated in the fuel cell portion 20. Both the vaporizing section 4 and the reforming section 6 are collectively referred to as “a fuel gas generator”.

The vaporizing section 4, the reforming section 6 and the fuel cell portion 20 are provided with electric heater/temperature sensors 4a, 6a and 8a, respectively. Electric resistance values of the electric heater/temperature sensors 4a, 6a and 8a depend on the temperature. Therefore, the electric heater/temperature sensors 4a, 6a and 8a also function as temperature sensors for measuring temperatures of the vaporizing section 4, the reforming section 6 and the fuel cell portion 20.

The vaporizer 41 heats liquid mixture sent from the pump 3 to approximately 110 to 160° C. by heat of the electric heater/temperature sensor 4a and the heat exchanger 42 and evaporates the liquid mixture. The gas mixture evaporated by the vaporizer 41 is sent to the reformer 61.

Catalysts are supported on a wall surface of the flow passage in the reformer 61. The reformer 61 heats gas mixture sent from the vaporizer 41 to approximately 300 to 400° C. by heat of the electric heater/temperature sensor 6a and the heat exchanger 62 and causes reforming reaction by the catalysts in the flow passage. That is, gas mixture (reformed gas) of hydrogen, carbon dioxide and an extremely small amount of carbon monoxide, etc. are produced by catalyst reaction between raw fuel and water. Here, hydrogen and carbon dioxide are fuel, and carbon monoxide is a by-product. When the raw fuel is methanol, vapor reforming reaction as mainly shown in the following equation (1) is caused in the reformer 61:

CH₃OH+H₂O→3H₂+CO₂ (1)

An extremely small amount of carbon monoxide is secondarily reproduced by the following equation (2) which is sequentially caused after the chemical equation (1):

H₂+CO₂→H₂O+CO (2)

Produced reformed gas is delivered to the electricity generating cell 8.

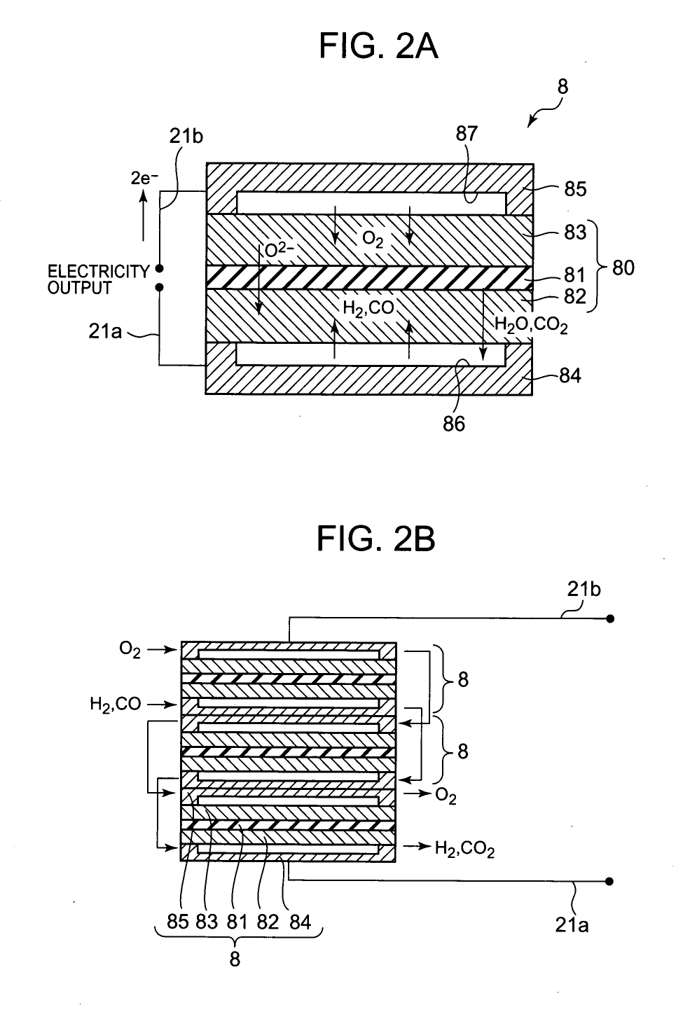

FIG. 2A is a schematic diagram of the electricity generating cell 8. The electricity generating cell 8 comprises an electric cell 80, a fuel electrode separator (fuel gas supply section) 84, and an oxygen electrode separator (oxidation gas supply section) 85. Here, the electric cell 80 has a solid oxide electrolyte 81 in which a fuel electrode 82 (anode) and an oxygen electrode 83 (cathode) are formed at the both surfaces. The fuel electrode separator 84 is bonded to the fuel electrode 82 and is formed with a fuel supply flow passage (fuel gas supply flow passage) 86 on the bonded surface. The oxygen electrode separator 85 is bonded to the oxygen electrode 83 and is formed with an oxygen supply flow passage (oxidation gas supply flow passage) 87 on the bonded surface.

Here, zirconia-based (Zr₁₋ₓYₓ) O_{2-x/2}(YSZ), lanthanum gallate-based (La₁₋ₓSrₓ) (Ga_{1-y-z}Mg_{y}Co_{z}) O₃, etc. can be used as the solid oxide electrolyte 81; La_{0.84}Sr_{0.16}MnO₃, La (Ni, Bi) O₃, (La, Sr) MnO₃, In₂O₃+SnO₂, LaCoO₃, etc. can be used as the fuel electrode 82; Ni, Ni+YSZ, etc. can be used as the oxygen electrode 83; and LaCr (Mg) O₃, (La, Sr) CrO₃, NiAl+Al₂O₃, etc. can respectively be used as the fuel electrode separator 84 and the oxygen electrode separator 85.

The electricity generating cell 8 is heated to approximately 500 to 1,000° C. by heat of the electric heater/temperature sensor 8a, and a later-described electrochemical reaction is caused.

Air is sent to the oxygen electrode 83 through the oxygen supply flow passage 87 of the oxygen electrode separator 85.

In the oxygen electrode 83, oxygen ions are produced as shown in the following equation (3) by oxygen in the air and electrons supplied from the cathode output electrode 21b;

O₂+4e³¹ 2O²⁻ (3)

The solid oxide electrolyte 81 is permeable to oxygen ions, and oxygen ions produced by the oxygen electrode 83 pass through the solid oxide electrolyte 81 and reach the fuel electrode 82.

Reformed gas delivered from the reformer 61 through the fuel supply flow passage 86 of the fuel electrode separator 84 is sent to the fuel electrode 82. In the oxygen electrode 83, reactions as shown in the following equations (4) and (5) between oxygen ions which pass through the solid oxide electrolyte 81 and reformed gas are caused:

H₂+O²⁻→H₂O+2e⁻ (4)

CO+O²⁻→CO₂+2e³¹ (5)

The fuel electrode separator 84 is connected to the anode output electrode 21a, and the oxygen electrode separator 85 is brought into conduction with the cathode output electrode 21b as will be described later. The anode output electrode 21a and the cathode output electrode 21b are connected to the DC/DC converter 902. Therefore, electrons produced in the fuel electrode 82 are supplied to the oxygen electrode separator 85 through the anode output electrode 21a, an external circuit such as the DC/DC converter 902 and the cathode output electrode 21b.

As shown in FIG. 2B, the cell stack may be formed by serially connecting a plurality of electricity generating cells 8 comprising the fuel electrode separator 84, the fuel electrode 82, the solid oxide electrolyte 81, the oxygen electrode 83 and the oxygen electrode separator 85. By serially connecting the plurality of electricity generating cells 8 to one another, output voltage can be increased. In this case, as shown in FIG. 2B, the fuel electrode separator 84 of the serially connected one end of the electricity generating cell 8 is connected to the anode output electrode 21a, and the oxygen electrode separator 85 of the other end of the electricity generating cell 8 is connected to the cathode output electrode 21b.

The heat exchangers 42 and 62 are formed with flow passages for unreacted reformed gas (exhaust gas 1) which passes through the fuel supply flow passage 86 of the fuel electrode separator 84, and with a flow passage for unreacted air (exhaust gas 2) which passes through the oxygen supply flow passage 87 of the oxygen electrode separator 85. The exhaust gas 1 and exhaust gas 2 are discharged out through discharging flow passages formed in the heat exchangers 42 and 62. The heat exchangers 42 and 62 heat the reformer 61 and the vaporizer 41 by heat discharged when the exhaust gas 1 and the exhaust gas 2 pass.

The exhaust gas 1 and the exhaust gas 2 which have passed through the discharge flow passages in the heat exchangers 42 and 62 are discharged out of the thermal insulation package 10.

Next, a concrete structure of the thermal insulation package 10 will be explained.

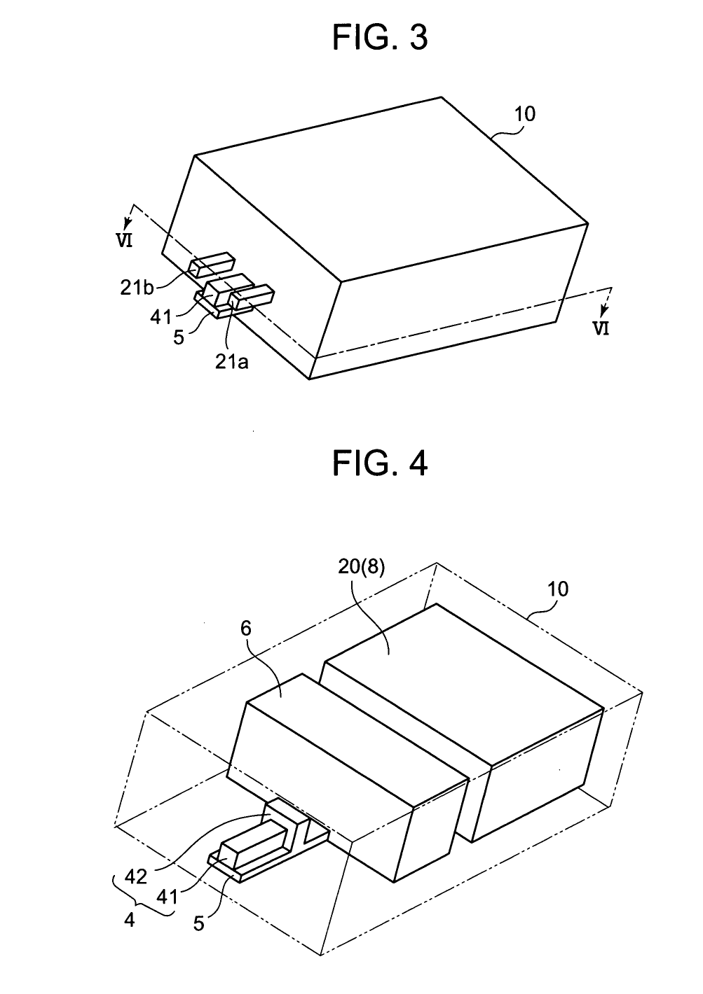

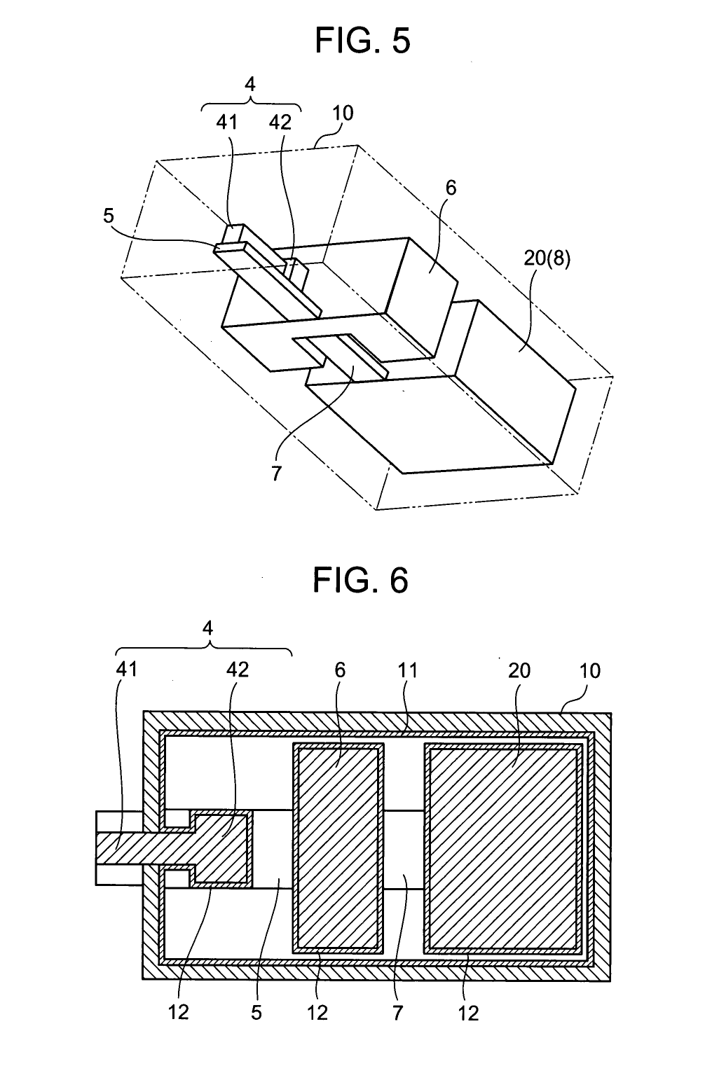

FIG. 3 is a perspective view of a thermal insulation package 10. FIG. 4 is a perspective view showing an internal structure of the thermal insulation package 10. FIG. 5 is a perspective view of the internal structure of the thermal insulation package 10 in FIG. 4. viewed from below. FIG. 6 is a sectional view taken along the line VI-VI in FIG. 3. As shown in FIG. 3, an inlet of the vaporizer 41 of the vaporizing section 4, the connecting portion 5, the anode output electrode 21a and the cathode output electrode 21b penetrate one of wall surfaces of the thermal insulation package 10.

As shown in FIGS. 4 to 6, the vaporizing section 4, the connecting portion 5, the reforming section 6, the connecting portion 7 and the fuel cell portion 20 are arranged in this order in the thermal insulation package 10. In FIGS. 4 to 6, the anode output electrode 21a, the cathode output electrode 21b, and a structure for connecting these electrodes and the fuel cell portion 20 with each other are omitted in order to simplify the figures.

The vaporizing section 4, the connecting portion 5, the reforming section 6, the connecting portion 7, the electricity generating cell 8 in the fuel cell portion 20, the thermal insulation package 10, the anode output electrode 21a and the cathode output electrode 21b are made of metal having high temperature resistance and appropriate thermal conductivity. These members can be formed using Ni-based alloy Inconel such as Inconel 783.

A radiation-preventing film 11 is formed on an inner wall surface of the thermal insulation package 10. Radiation-preventing films 12 are formed on outer wall surfaces of the vaporizing section 4, the connecting portion 5, the reforming section 6, the connecting portion 7 and the fuel cell portion 20. The radiation-preventing films 11 and 12 prevent heat from transferring by radiation, and the films may be made of Au or Ag for example. It is preferable that at least one of the radiation-preventing films 11 and 12 is provided, and more preferably, both the films are provided.

The vaporizing section 4 penetrates the thermal insulation package 10 together with the connecting portion 5, and the vaporizing section 4 and the reforming section 6 are connected to each other through the connecting portion 5. The reforming section 6 and the fuel cell portion 20 are connected to each other through the connecting portion 7.

As shown in FIGS. 4 and 5, the vaporizing section 4, the connecting portion 5, the reforming section 6, the connecting portion 7 and the fuel cell portion 20 are integrally formed together. Lower surfaces of the connecting portion 5, the reforming section 6, the connecting portion 7 and the fuel cell portion 20 are flush with each other.

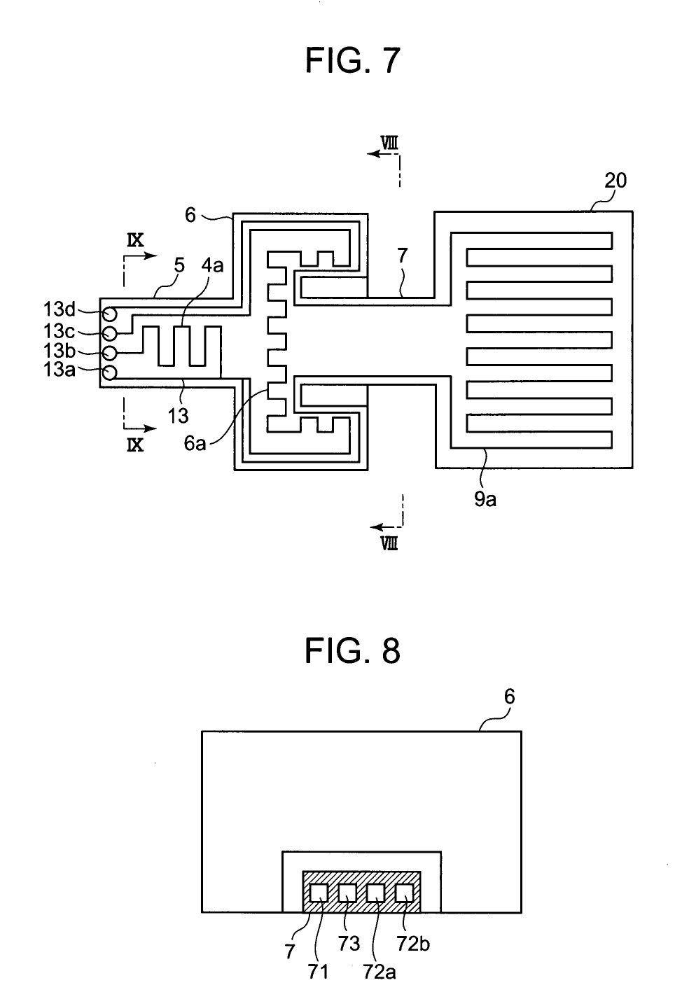

FIG. 7 is a bottom view of the connecting portion 5, the reforming section 6, the connecting portion 7 and the fuel cell portion 20. FIG. 8 is a sectional view taken along the line VIII-VIII in FIG. 7. In FIGS. 7 and 8, the anode output electrode 21a and the cathode output electrode 21b are omitted.

A portion of the reforming section 6 which is connected to the connecting portion 7 is retreated from a surface of the reforming section 6 opposed to the fuel cell portion 20. Therefore, the connecting portion 7 may be made long so that thermal conductivity from the fuel cell portion 20 to the reforming section 6 can be reduced, and a distance between the fuel cell portion 20 and the reforming section 6 is shortened to make the apparatus compact.

As shown in FIG. 7, lower surfaces of the connecting portion 5, the reforming section 6, the connecting portion 7 and the fuel cell portion 20 are subjected to insulating processing using ceramic, etc. and then, a wiring pattern 13 is formed on the lower surfaces. The wiring pattern 13 is formed in bellows form on a lower portion of the vaporizing section 4, a lower portion of the reforming section 6 and a lower portion of the fuel cell portion 20, and these portions become the electric heater/temperature sensors 4a, 6a and 8a, respectively. One ends of the electric heater/temperature sensors 4a, 6a and 8a are connected to a common terminal 13a, and the other ends of the sensors are connected to three independent terminals 13b, 13c and 13d, respectively. These four terminals 13a, 13b, 13c and 13d are formed on the ends located outer side than the thermal insulation package 10 of the connecting portion 5.

A portion of the connecting portion 5 which penetrates the thermal insulation package 10 is insulated so that the electric heater/temperature sensors 4a, 6a and 8a are not brought into conduction with the thermal insulation package 10.

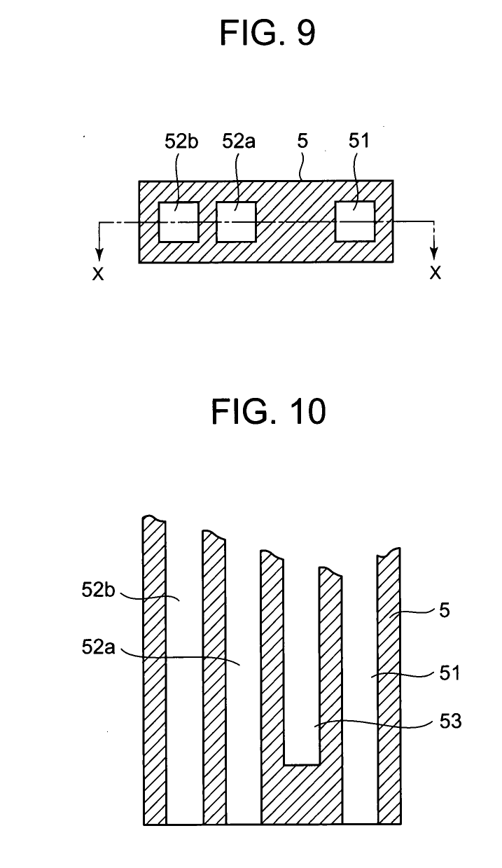

FIG. 9 is a sectional view taken along the line IX-IX in FIG. 7. FIG. 10 is a sectional view taken along the line X-X in FIG. 9.

The connecting portions 5 and 7 are respectively provided with air supply flow passages 51 and 71, discharge flow passages 52a and 72a, and discharge flow passages 52b and 72b. The air supply flow passages 51 and 71 are for supplying air to the oxygen electrode 83 of the electricity generating cell 8. The discharge flow passages 52a and 72a are for exhaust gas 1 discharged from the fuel cell portion 20. The discharge flow passages 52b and 72b are for exhaust gas 2 discharged from the fuel cell portion 20. The connecting portion 5 is provided with a supply flow passage 53 for gas fuel delivered to the reforming section 6 from the vaporizing section 4. The connecting portion 7 is provided with a supply flow passage 73 for reformed gas delivered from the reforming section 6 to the fuel electrode 82 of the electricity generating cell 8.

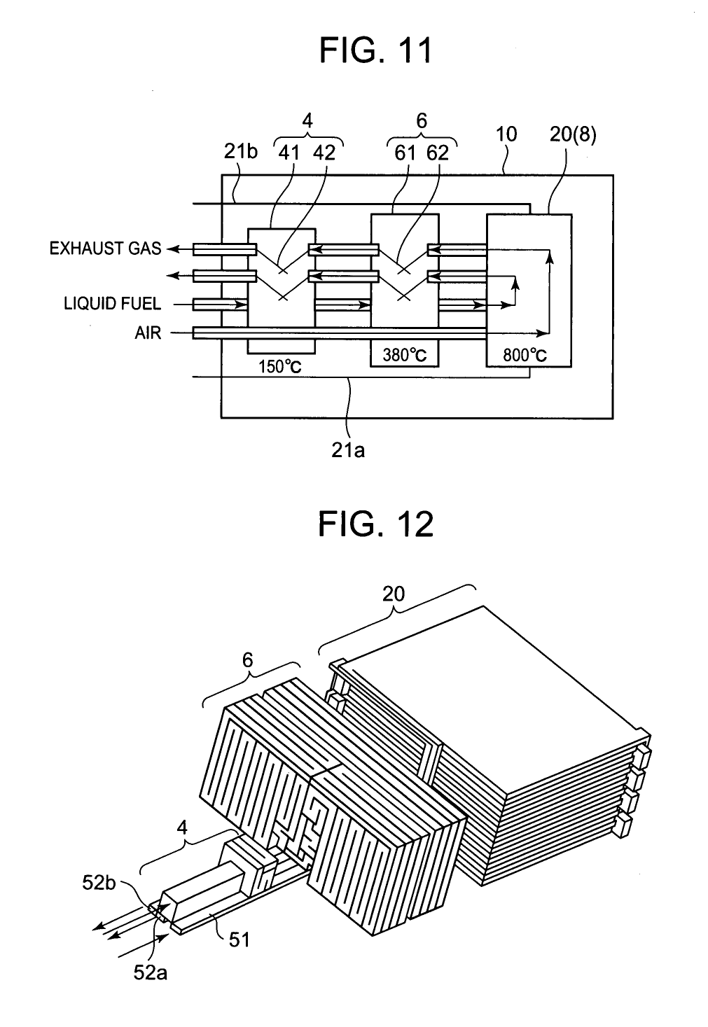

FIG. 11 is a schematic diagram showing a temperature distribution in the thermal insulation package 10 at the time of steady operation. As shown in FIG. 11, for example, when the temperature of the fuel cell portion 20 is kept at approximately 800° C., heat is moved to the reformer 61 from the fuel cell portion 20 through the connecting portion 7, and to outside of the vaporizing section 4 and the thermal insulation package 10 from the reformer 61 through the connecting portion 5. As a result, the temperature of the reformer 61 is kept at approximately 380° C. and the temperature of the vaporizing section 4 is kept at approximately 150° C.

The anode output electrode 21a and the cathode output electrode 21b are pulled out from the fuel cell portion 20, and penetrate the same wall surface as that through which the vaporizing section 4 and the connecting portion 5 of the thermal insulation package 10 penetrate. Therefore, the heat transfer path by the anode output electrode 21a and the cathode output electrode 21b can be made longer, and heat of the fuel cell portion 20 moving outside of the thermal insulation package 10 through the anode output electrode 21a and the cathode output electrode 21b can be reduced.

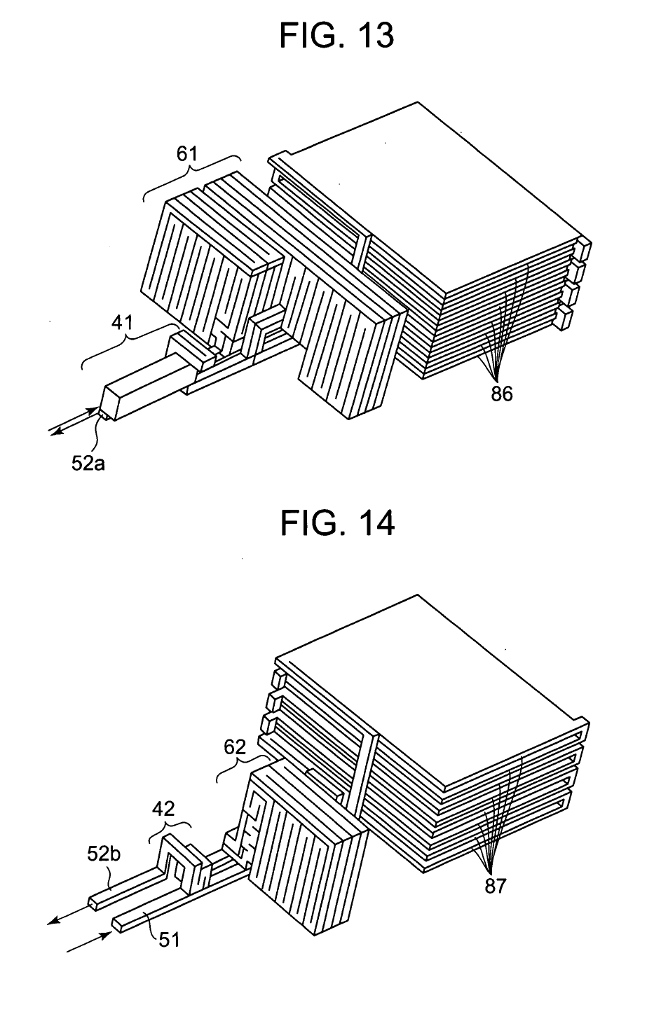

Next, a structure of the flow passage in the thermal insulation package 10 will be explained. FIG. 12 is a perspective view showing the structure of the flow passage in the thermal insulation package 10. FIG. 13 is a perspective view showing the flow passage on the side of the anode. FIG. 14 is a perspective view showing the flow passage on the side of the cathode.

As shown in FIG. 13, the flow passage on the side of the anode of the vaporizing section 4 and the reforming section 6 become the vaporizer 41 and the reformer 61. As shown in FIG. 14, the flow passage on the side of the cathode of the vaporizing section 4 and the reforming section 6 become the heat exchangers 42 and 62.

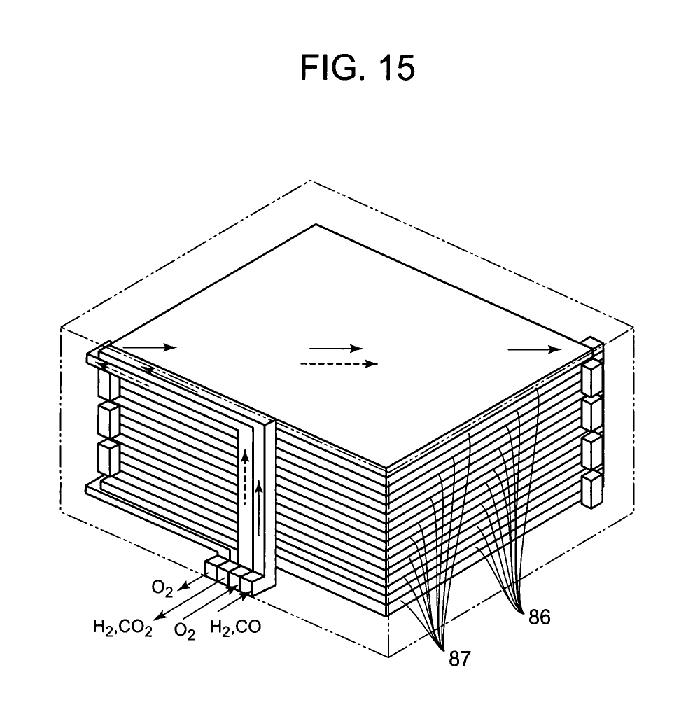

FIG. 15 is a perspective view showing a structure of the flow passage in a casing of the fuel cell portion 20. As shown in FIGS. 13 to 15, in the casing of the fuel cell portion 20, the fuel supply flow passages 86 formed on the fuel electrode separator 84 and the oxygen supply flow passages 87 formed on the oxygen electrode separator 85 are alternately disposed. Although it is not illustrated in FIGS. 13 to 15, the solid oxide electrolyte 81, and the fuel electrode 82 and the oxygen electrode 83 (cathode) both of which are formed on both surfaces of the solid oxide electrolyte 81 are sandwiched between the fuel electrode separator 84 formed with the fuel supply flow passage 86 and the oxygen electrode separator 85 formed with the oxygen supply flow passage 87. The electricity generating cell 8 has a stack structure in which the sandwiched structures are stacked in a plurality of layers.

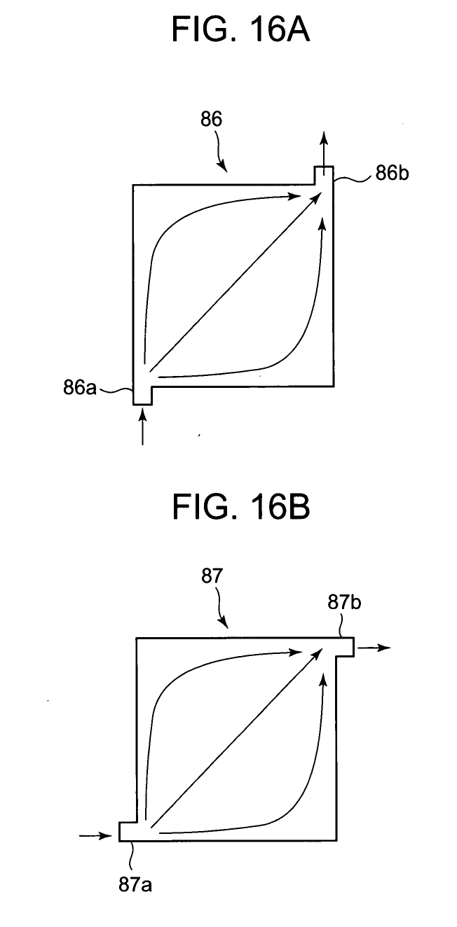

FIG. 16A is a schematic diagram showing a flow of reformed gas in the fuel supply flow passage 86. FIG. 16B is a schematic diagram showing a flow of air in the oxygen supply flow passage 87. As shown in FIGS. 16A and 16B, the fuel supply flow passage 86 and the oxygen supply flow passage 87 are formed in square forms, and gas inflow portions 86a and 87a and gas outflow portions 86b and 87b are provided at diagonal locations. The stack structure in which the plurality of electricity generating cells 8 are stacked in the plurality of layers is employed. Thus, the inflow portions 86a and 87a and the outflow portions 86b and 87b are not located at the same positions in the fuel supply flow passage 86 and the oxygen supply flow passage 87.

The heights of the fuel supply flow passage 86 and the oxygen supply flow passage 87 (a gap between the fuel electrode 82 and the fuel electrode separator 84 and a gap between the oxygen electrode 83 and the oxygen electrode separator 85 in portions corresponding to each of the flow passages) are 500 μm or less. The fuel supply flow passage 86 and the oxygen supply flow passage 87 may be rectangular in shape, and they need not be of square shape.

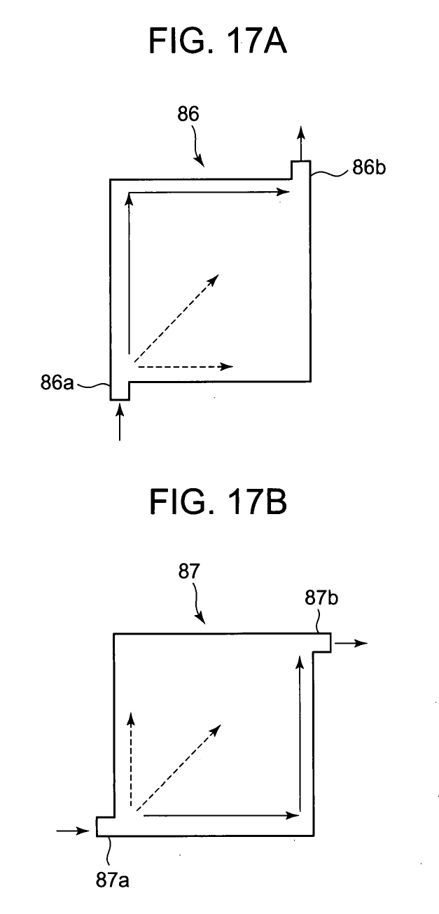

Generally, when the height of the flow passage is greater than 500 μm, as shown with solid arrows in FIGS. 17A and 17B, gas flows straightly from the inflow portion of the angle and flows along the wall surfaces of the rectangular shape, the gas changes the flowing direction at the angle and flows out from the outflow portion which is diagonal to the inflow portion. Thus, gas does not easily flow in a direction from the inflow portion toward the outflow portion, or in a direction perpendicular to the inflow direction (broken arrows in FIGS. 17A and 17B).

However, when the heights of the fuel supply flow passage 86 and the oxygen supply flow passage 87 are equal to or less than 500 μm, viscosity of the reformed gas near the fuel electrode 82 and the fuel electrode separator 84, and viscosity of the air near the oxygen electrode 83 and the oxygen electrode separator 85 influence the entire region of the flow passage in the height direction. Thus, as shown in FIGS. 16A and 16B, gas flows not only straightly from the inflow direction but also in directions toward the outflow portions 86b and 87b from the inflow portions 86a and 87a, and in a direction perpendicular to the inflow direction. Then, the gas spreads to the entire region in the flow passage. Therefore, the reformed gas and the air can uniformly be supplied to the entire fuel electrode 82 and oxygen electrode 83.

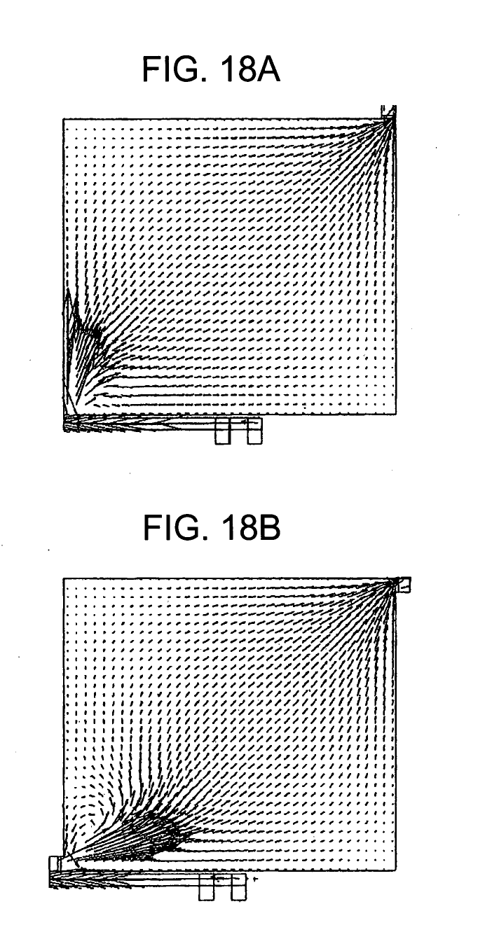

FIGS. 18A and 18B show results of simulations of the reformed gas flow and the air flow in the fuel supply flow passage 86 and the oxygen supply flow passage 87, and arrows in the drawings show directions of flows and vectors showing flow speed. It can be found that in either of the fuel supply flow passage 86 and the oxygen supply flow passage 87, reformed gas and the air spread to the entire flow passage, and they flow from the inflow portions 86a and 87a toward the outflow portions 86b and 87b.

As described above, according to the embodiment, rectangular fuel supply flow passage 86 and rectangular oxygen supply flow passage 87 in which gas flows in the diagonal direction are used instead of the bellows flow passage, so that the flow passage can be made relatively short and relatively wide. With this, the pressure loss can be reduced. Thus, pressure generated by a pump for sending fuel gas and air into the electricity generating cell can be reduced, the pump can be made compact and as a result, the fuel cell apparatus can be made compact.

When the heights of the fuel supply flow passage 86 and the oxygen supply flow passage 87 are set to 500 μm or less, a wall surface effect in which, for example, the viscosity of the flow passage influences the entire cross section of the flow passage, is increased. Thus, the reformed gas and the air uniformly spread to the entire regions of the fuel supply flow passage 86 and the oxygen supply flow passage 87. Therefore, the reformed gas and the air can uniformly be supplied to the entire fuel electrode 82 and the oxygen electrode 83.

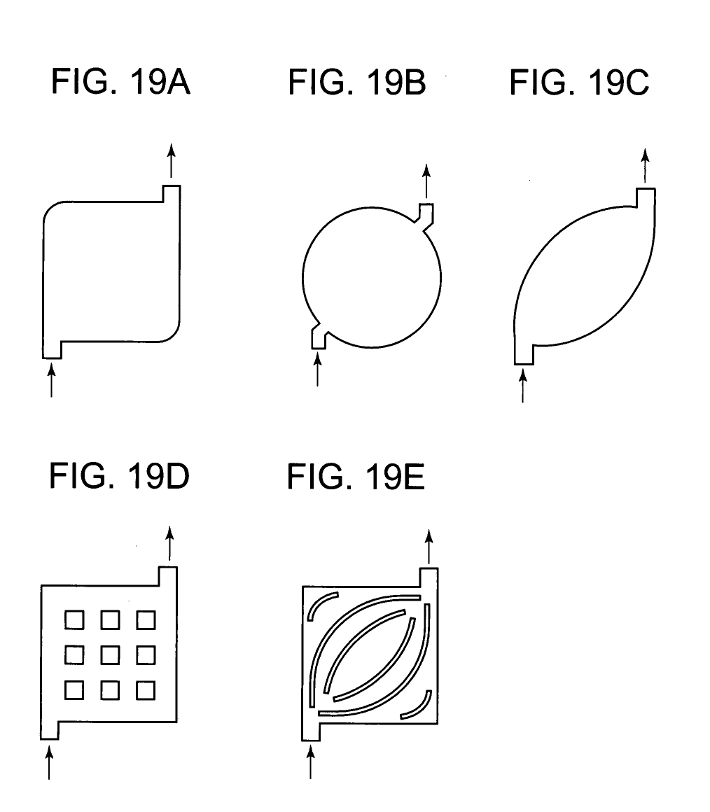

Although each flow passage is formed in a rectangular shape in this embodiment, as shown in FIGS. 19A to 19E, the shape of the flow passage is not limited to the rectangular shape. FIG. 19A shows a rectangular shape whose angle portions are curved, FIG. 19B shows a circular shape, FIG. 19C shows a substantially elliptic shape (football shape), and FIGS. 19D and 19E show shapes having diaphragms in places. The rectangular shape of this embodiment and the shapes shown in FIGS. 19A to 19E are called “substantially rectangular shapes”.

As shown in FIGS. 19D and 19E, one or more diaphragms may be provided if necessary at locations where flows of the fuel gas and oxygen in the air are not hindered greatly.

In order to uniformly supply fuel and oxygen in the air entirely, as shown in FIGS. 19A to 19E, it is preferable that the flow passages are provided symmetrically with respect to a line segment connecting the inflow portion and the outflow portion, or with respect to an intermediate point of the line segment, but the flow passages need not be strictly symmetric.

### MODIFIED EXAMPLE

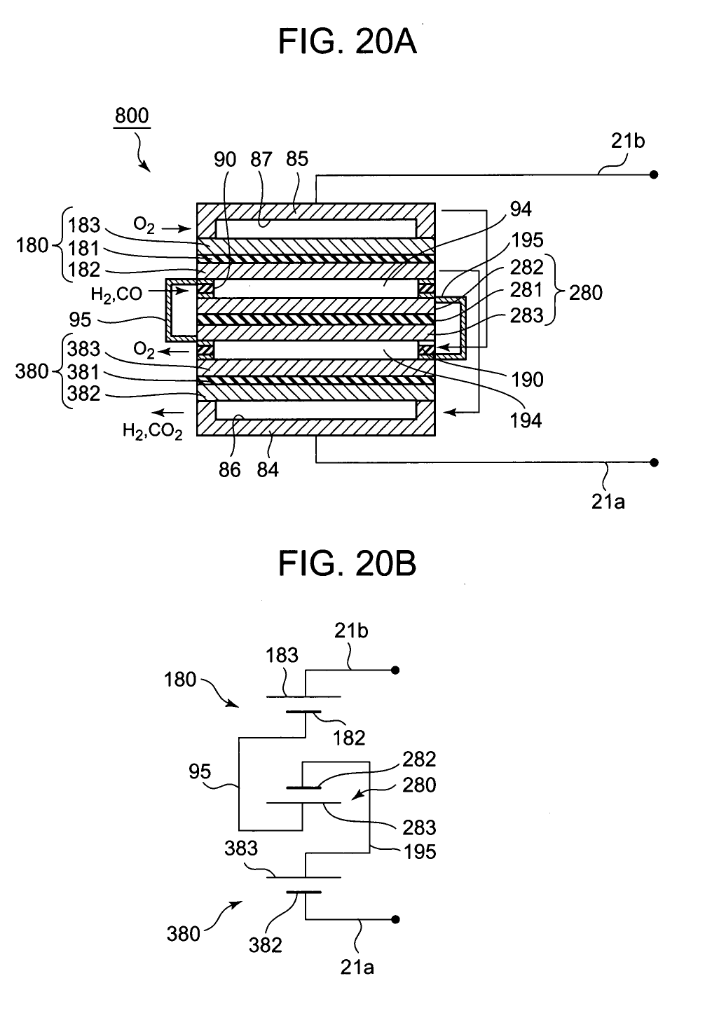

FIG. 20A is a schematic diagram showing a modified example of the stack structure of the electricity generating cell. FIG. 20B is a circuit diagram of FIG. 20A. In FIGS. 20A and 20B, three electric cells 180, 280 and 380 comprising a fuel electrode, a solid oxide electrolyte and an oxygen electrode are serially connected to one another, but the center electric cell 280 has a different stacking direction from those of the other two electric cells 180 and 380.

That is, in FIG. 20A, an oxygen electrode separator 85, an oxygen electrode 183, a solid oxide electrolyte 181, a fuel electrode 182, a diaphragm material 90, a fuel electrode 282, a solid oxide electrolyte 281, an oxygen electrode 283, a diaphragm material 190, an oxygen electrode 383, a solid oxide electrolyte 381, a fuel electrode 382 and the fuel electrode separator 84 are stacked in this order from above, thereby forming a cell stack 800.

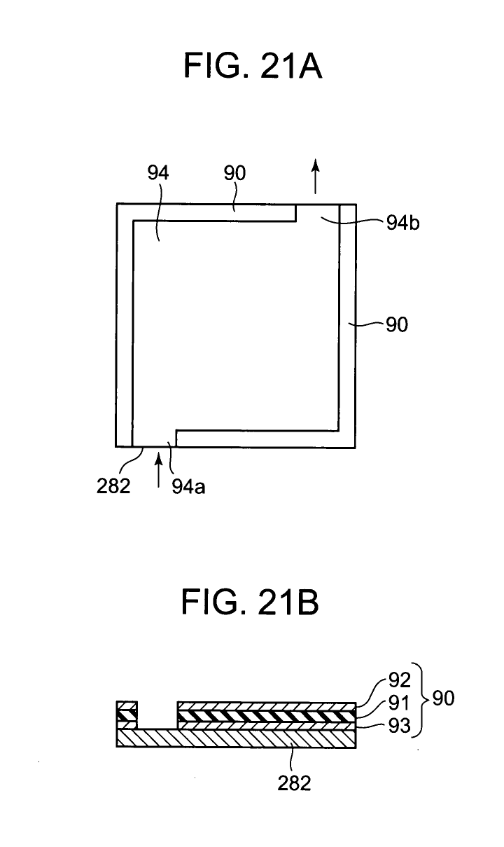

FIG. 21A is a plan view showing the diaphragm material 90 superposed on the fuel electrode 282. FIG. 21B is a front view of FIG. 21A.

The diaphragm material 90 is disposed in a form of a rectangular frame. A rectangular fuel supply flow passage 94 is formed between the fuel electrodes 182 and 282. An inflow portion 94a and an outflow portion 94b for reformed gas are provided at diagonal locations of the fuel supply flow passage 94.

The diaphragm material 90 comprises an insulative frame 91 made of an insulative material. The insulative frame 91 is provided at the both surfaces with conductive interconnects 92 and 93. The interconnect 92 abuts against the fuel electrode 182, and the interconnect 93 abuts against the fuel electrode 282.

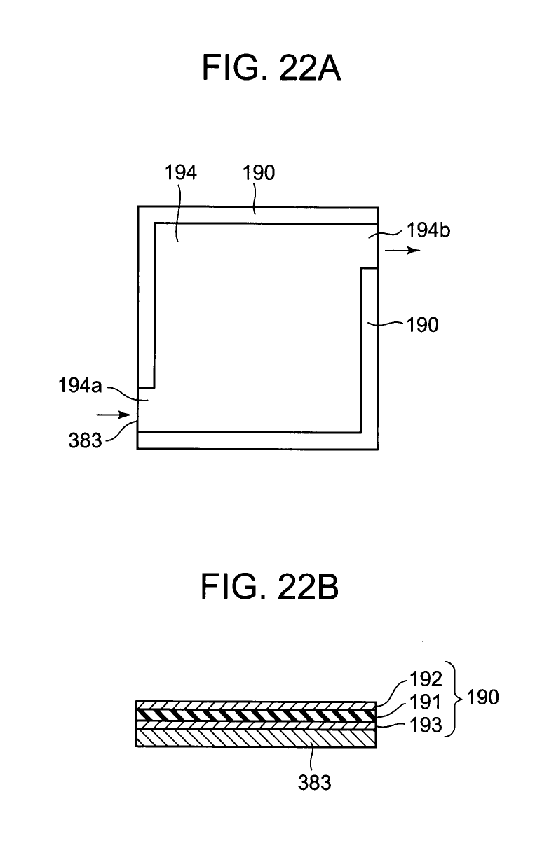

FIG. 22A is a plan view showing the diaphragm material 190 superposed on the oxygen electrode 383. FIG. 22B is a front view of FIG. 22A.

The diaphragm material 190 is disposed in a form of a rectangular frame. The diaphragm material 190 has a rectangular oxygen supply flow passage 194 formed between the oxygen electrodes 283 and 383. Air inflow portion 194a and air outflow portion 194b are provided at diagonal locations of the oxygen supply flow passage 194.

The diaphragm material 190 comprises an insulative frame 191 made of an insulative material. The insulative frame 191 is provided at its both surfaces with conductive interconnects 192 and 193. The interconnect 192 abuts against the oxygen electrode 283, and the interconnect 193 abuts against the oxygen electrode 383.

The interconnect 92 and the interconnect 192 are electrically continuous with each other through an electric conductor 95. In the same manner, the interconnect 93 and the interconnect 193 are electrically continuous with each other through an electric conductor 195.

The oxygen supply flow passage 87 and the oxygen supply flow passage 194 are connected to an air supply flow passage (not shown) for supplying air. When air is supplied to the oxygen supply flow passages 87 and 194, oxygen is supplied to the oxygen electrodes 183, 283 and 383.

The fuel supply flow passage 86 and the fuel supply flow passage 94 are connected to a reformed gas supply passage (not shown) for supplying reformed gas. When reformed gas is supplied to the fuel supply flow passages 86 and 94, reformed gas is supplied to the fuel electrodes 182, 282 and 382.

When reformed gas and air are supplied in a state where the cell stack 800 is heated to approximately 500 to 1,00020 C., the above-described electrochemical reaction is caused, and electricity is generated by the cell stack 800.

As described above, according to this modified example, fuel electrodes and oxygen electrodes of adjacent electric cells are opposed to each other and the flow passages are formed between the adjacent electrodes. Therefore, the number of flow passages having the same shapes as those of the above-described embodiment can be reduced and thus, the pressure loss can be reduced. When the height of the flow passage is set to the same value as that of the above-described embodiment so as to increase the wall surface effect, the entire thickness of the cell stack 800 can be reduced and the fuel cell apparatus can be made compact.

Although the solid oxide fuel cell has been explained in the above embodiment, the present invention is not limited to this, and the embodiment or the present invention can also be applied to a solid high polymer fuel cell and other kinds of fuel cells.

All of disclosures of Japanese Patent Application No. 2006-261028 filed on Sep. 26, 2006 including specification, claims, drawings and abstract are incorporated in this specification by reference.

Although a typical embodiment has been showed and explained above, the present invention is not limited to the embodiment. Thus, the scope of the invention is limited only by the following claims.

What is claimed is:

1. A fuel cell comprising:
an electric cell in which an anode is formed on one surface of an electrolyte and a cathode is formed on the other surface of the electrolyte;
a fuel gas supply section which is disposed on a side of the anode and which is formed with a fuel gas supply flow passage through which fuel gas is supplied to the anode; and
an oxidation gas supply section which is disposed on a side of the cathode and which is formed with an oxidation gas supply flow passage through which oxidation gas is supplied to the cathode, wherein
at least one flow passage of the fuel gas supply flow passage and the oxidation gas supply flow passage is substantially rectangular in shape.

2. The fuel cell according to claim 1, wherein
the one flow passage of the fuel gas supply flow passage and the oxidation gas supply flow passage, which is substantially rectangular in shape has an inflow portion through which gas is supplied and an outflow portion through which gas is discharged, and
the flow passage is substantially symmetric with respect to a line segment connecting the inflow portion and the outflow portion, or with respect to an intermediate point of the line segment.

3. The fuel cell according to claim 1, wherein
a height of the one flow passage of the fuel gas supply flow passage and the oxidation gas supply flow passage, which is substantially rectangular in shape, is 500 μm or less.

4. A fuel cell stack comprising a plurality of fuel cells according to claim 1.

5. The fuel cell stack according to claim 4, wherein
the plurality of fuel cells are disposed such that anodes of the electric cells of adjacent fuel cells are opposed to each other.

6. The fuel cell stack according to claim 5, wherein
the electric cells of adjacent fuel cells sandwich a diaphragm material which is provided with a conductive interconnect disposed at both surfaces of an insulative frame made of an insulative material by using the anodes of the adjacent electric cells, and
the opposed two anodes and the diaphragm material form the fuel gas supply flow passage.

7. The fuel cell stack according to claim 4, wherein
the plurality of fuel cells are disposed such that cathodes of the electric cells of adjacent fuel cells are opposed to each other.

8. The fuel cell stack according to claim 7, wherein
the electric cells of adjacent fuel cells sandwich a diaphragm material which is provided with a conductive interconnect disposed at both surfaces of an insulative frame made of an insulative material by using the cathodes of the adjacent electric cells, and
the opposed two cathodes and the diaphragm material form the oxidation gas supply flow passage.

9. A fuel cell apparatus comprising:
the fuel cell according to claim 1;
a fuel container which stores fuel therein; and
a fuel gas generator which generates fuel gas from the fuel, wherein
the electric cell generates electrical energy by using the fuel gas.

10. An electronic instrument comprising:
the fuel cell apparatus according to claim 9; and
an electronic instrument main body of the fuel cell apparatus, which is operated by the electrical energy generated by the electric cell included in the fuel cell apparatus.

11. A fuel cell stack comprising:
a plurality of fuel cells, wherein
each of the fuel cells includes;
an electric cell in which an anode is formed on one surface of an electrolyte and a cathode is formed on the other surface of the electrolyte;
a fuel gas supply section which is disposed on a side of the anode and which is formed with a fuel gas supply flow passage through which fuel gas is supplied to the anode; and
an oxidation gas supply section which is disposed on a side of the cathode and which is formed with an oxidation gas supply flow passage through which oxidation gas is supplied to the cathode, wherein
the plurality of fuel cells are disposed such that anodes or cathodes of the electric cells of adjacent fuel cells are opposed to each other.

12. The fuel cell stack according to claim 11:
the electric cells of adjacent fuel cells sandwich a diaphragm material which is provided with a conductive interconnect disposed at both surfaces of an insulative frame made of an insulative material by using the cathodes of the adjacent electric cells, and
the opposed two cathodes and the diaphragm material form the oxidation gas supply flow passage.

13. A fuel cell apparatus comprising:
the fuel cell stack according to claim 11;
a fuel container which stores fuel therein; and
a fuel gas generator which generates fuel gas from the fuel, wherein
the electric cells generate electrical energy by using the fuel gas.

14. An electronic instrument comprising:
the fuel cell apparatus according to claim 13; and
an electronic instrument main body of the fuel cell apparatus, which is operated by the electrical energy generated by the electric cells included in the fuel cell apparatus.
